(19) United States
(12) Patent Application Publication
(10) Pub. No.: US 2015/0177940 A1
(43) Pub. Date: Jun. 25, 2015

(54) SYSTEM, ARTICLE, METHOD AND APPARATUS FOR CREATING EVENT-DRIVEN CONTENT FOR ONLINE VIDEO, AUDIO AND IMAGES

(71) Applicant: Clixie Media, LLC, Ann Arbor, MI (US)

(72) Inventors: Gerardo Trevino, Monterrey (MX); Juan Lauro Aguirre, Cedar Park, TX (US); Larry H. Moore, Ann Arbor, MI (US); Timothy J. Moore, Ann Arbor, MI (US); Bud L. Raymor, Ann Arbor, MI (US)

(21) Appl. No.: 14/572,392

(22) Filed: Dec. 16, 2014

Related U.S. Application Data
(60) Provisional application No. 61/918,700, filed on Dec. 20, 2013.

(51) Int. Cl. G06F 3/0484; H04L 29/08

(52) U.S. Cl. CPC G06F 3/0484; H04L 67/10

(57) ABSTRACT

What is provided is a system, computer-implemented method, apparatus and article for interacting with video, audio and/or picture content by providing business rules, response rules, instructions and/or URL pointer data for client side generation. The system does not receive nor store the video, audio and/or picture content, nor the interactive content piece to be enabled upon the video, audio and/or picture content.

### PRIORITY CLAIM

This patent application claims priority to and the benefit of the filing date of provisional patent application U.S. Ser. No. 61/918,700 filed on Dec. 20, 2013, which is incorporated herein in its entirety.

### FIELD

This patent application relates to creating event-driven content for online video, audio and images adapted for playing on a computing platform.

### BACKGROUND

Event-driven content enabled upon a video is known, which is adapted for viewing upon a computing platform, including event-driven content that is adapted for a user to select for displaying upon the computing platform. Methods for creating event-driven content are known, including a client sending a video file to a system for adding event-driven content. The system creates the interactive enabled content by: tagging images within the video for overlaying content; creating or receiving the event-driven content to be enabled upon the video; associating event-driven content with the tagged images; coding an embedded bedded file with the event-driven content and image tagging information for where/when to make the event-driven content accessible within the video; compiling the embedded file onto the video file; and sending the embedded video file back to the client. Such systems typically store the video files and imbedded content files, and the system creates the embedded video file by a system server and then sends the package of the video, event-driven content and overlaying instructions, back to the client. Prior systems may use Flash coding and Flash players for the event-driven content and video playback. The imbedded content is pre-defined and static once encoded into the embedded file. The embedded code includes instructions and content for responding to events enabled upon the video, and user clicks or selections of event-driven content for executing the event-driven content. This means that interactive responses are pre-defined and fixed in the embedded code that is sent to a user device for playing. The event-driven content does not change for different users viewing the embedded video. Typically, if event-driven content is selected by a user, the video play stops.

### SUMMARY

What is provided is a system, computer-implemented method, apparatus and article for creating event-driven content for online video, audio and images using a source video, audio and/or picture file by providing business rules, response rules, instructions and/or URL pointer data for client side generation, and/or viewing of event-driven content upon the source video, audio and/or picture file. The system does not receive nor store the source video, audio and/or picture files, nor the interactive source file(s) (i.e. Clixies™).

The management system may be provided to users as Software as a Service (“SaaS”) that includes: 1. a management tool; 2, an authoring toot; and, 3. an analytics tool. The management system is accessible through a standard HTML5 web browser and does not require dedicated computer hardware or software. The management tool allows a user to manage the videos, interactive source files (such as Clixies™) and visual markers. The authoring tool allows a user to produce the event-driven content for the videos, audio and pictures. The analytics tool allows a user to view statistics about web users' interactions with the videos, audio and pictures.

The management tool of the backend server is adapted to interact/manage all elements contained within the system, such as (but not limited to) content, interactive source files (such as Clixies™), visual markers, etc.

The authoring tool of the backend server is adapted to provide instructions to a client or web user's computing platform for mapping event-driven content to a video, audio and/or picture source file, and for mapping and synchronizing the event-driven content to the source file.

The authoring tool is adapted for authoring, creating, and/or mapping the event-driven content and the synchronization of the event-driven content for the source content; based upon the business rules, response rules, instructions and/or pointers in the backend server. The tool may generate multiple event-driven content actions for an event and have different event content displayed for different users based upon user data, such as user location. The authoring tool is used to create event-driven content enabled upon video, audio and/or image content. This is done without having to download or install hardware/software on the author's computing platform, or sending the content to a third-party service provider for packaging embedded code files with the content; or for encoding, decoding or hosting the video files for adding the event-driven content. The authoring tool allows for new event-driven content to be added to a video, audio or image; or the event-driven content to be edited for a video, audio or image, without requiring the author to reproduce the video, audio or image with the event-driven content by encoding, decoding or packaging it. The authoring tool is adapted to provide different event-driven content based upon a viewers geographic location.

The analytics tool of the management system is adapted to provide tracking and reporting of user behavior with the event-driven content, such as, but not limited to, clicks, false clicks, geographic location, local time, heat map, etc.

The system may include one or more analytics metrics adapted for use in tracking and analyzing user interaction with the event-driven content. For example, the user's order of selections of the event-driven content may be tracked. For example, “false clicks” or areas where a user clicks in an attempt to view event-driven content (even if no content exists at the position of the user click) may be tracked. For example, user click-through to a third party website for viewing and/or purchasing products features in event content may be tracked.

The backend server comprises an application layer, HTTP server, independent database layer and a response server. The application layer allows the web user to define the event-driven content. The HTTP server helps to deliver web content that can be accessed through the Internet, the independent database layer stores all information related to the system and users. The response server is a module designed to escalate and respond to a large number of users. The backend server responds to the following events such as, but is not limited to, video start, video click, video stop, video pause, video play, click, tap, etc. created b r the web users through the HTTP/HTTPS protocols (but is not limited to these). Upon the web user creating an event, such event then determines which action(s) to communicate to the web user. The system is adapted to create event-driven content that may be selected by a user without interrupting video/audio play.

The application layer is adapted for storing business rules, response rules, instructions and/or pointer data in a rules database, for use in generating event-driven content upon a source file. When an event occurs, the application layer processes the event in the following manner: 1) receives event—the system will register the event, detect the user and determine the object detection mechanism; 2) object detection—determines if the event was generated in an object previously defined; 3) resolves action—if an object has been detected or not, this step will generate the calculated properties and define a proper response; and 4) respond action—a response is sent to the web user. The rules and/or instructions may be used to define multiple event-driven content to be associated with a Clixie™ and/or visual marker. The Clixies™ and/or visual markers may include more than one form of content, such as but not limited to, image, text, audio, video, forms, animation, social links, URL, HTML content, third party website content, and the like), and/or may include different content to be associated with the video, audio or image file depending upon one or more user data and/or event properties, such as the user's geographic location. For example, depending upon a geographic location of a user, event-driven content may be displayed in different languages and/or include different retail sources for purchasing products highlighted by the event-driven content.

The system includes a library or database for indexing visual markers, Clixies™ and video/audio/image information. The visual markers can be used to identify what image on the video is event-driven, type of response the web user will receive (i.e. a “shopping cart” visual marker may take you to eCommerce site) or the visual marker can be an event-driven action itself, which will also respond accordingly. The Clixies™ are HTML, json and/or xml based content, which may be indexed locally (on the backend) or remotely from the system. The Clixies may use at least one (1) URL to the indexed image source content (the source content is stored remotely from the backend server, such as in a cloud based or third party repository); and requires a URL for the event-driven content (i.e. eCommerce, informational or social). Additionally, at least one reference to the backend server business rule(s) used for creating a response for the event-driven content for the video/audio/image, including (but not limited to): banner display, page jump or dependent actions; and at least one URL to the event-driven content (which is indexed remotely from the backend server, such as in a cloud based or third party memory).

The Clixies™ and/or visual markers may include (but are not limited to) image data, text data, video data, one or more URLs for one or more third party websites, HTML content for accessing further third party website content beyond the event-driven content, and other content. The Clixies™ and/or visual markers data (apart from the event-driven content data comprising the URL pointers indexed in the event library described above) may be indexed in one or more third party databases on the client side with, a viewing user or other user, or in a cloud-based storage, or remotely with a third party.

The source video/audio/image content may be stored in one or more third party databases on the client side with an author user, a viewing user or other user, or in a cloud based storage, or remotely with a third party.

The system includes a web portal that has an HTML5-based graphical user interface (GUI) adapted for display upon a web user-computing platform, for users to access the management system of the backend server. HTML 5 is used for at least one example. Users may include, but are not limited to, viewing users and author users.

The system may optionally include a client side, cloud-based or remote content repositories for storing source video/audio/image content. Other system examples do not include a repository for source video/audio/image, but use content stored by authors/creators of the event-driven content or other users.

The system may optionally integrate into one or more client side computing platforms. Other system examples may not include integration into client side computing platforms.

Unlike prior systems, the present system does not store or load event-driven content responses in code added to or embedded in the source video/audio/image. The present system does not store or edit source video/audio/image content. It does not change the video/audio/image file format. The present system does not store enabled. content on the server side, but instead use event-driven content to determine responses from the back-end server that remains either on the client side or with a third party.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a system diagram illustrating an example system for tracking events in source content;

FIG. 2 is a flow chart illustrating an example method of processing an event to generate an action, by the system of FIG. 1;

FIG. 3 illustrates an example sensitive area enabled upon a video play area of a web portal of the present system;

FIG. 4 is a system diagram illustrating a second example system for generating or viewing event-driven content enabled upon a source video;

FIG. 5 is a flow chart illustrating an example method of displaying event-driven content, by the present system;

FIG. 6 is a block diagram illustrating the backend server architecture;

FIG. 7 is a graphical user interface drawing illustrating an example GUI for the authoring tool of the present application;

FIG. 8 is a graphical user interface drawing illustrating an example GUI for editing projects with the authoring tool of the present application;

FIG. 9 is a graphical user interface drawing illustrating an example GUI for associating/linking an already created Clixie™ (indexed in a library) to a source video, to be accessed by the authoring tool of the present application;

FIG. 10 is a graphical user interface drawing illustrating an example GUI for creating new Clixies™ to be accessed by the authoring tool of the present application; and

FIG. 11 is a graphical user interface drawing illustrating an example GUI for associating a visual marker with a Clixie™ to be accessed by the authoring tool of the present application.

### DETAILED DESCRIPTION

In the following detailed description, numerous specific details are set forth in order to provide a thorough understanding of the examples as defined in the claimed subject matter, and as an example of how to make and use the subject matter described herein. However, it will be understood by those skilled in the art that claimed subject matter is not intended to be limited to such specific details and may even be practiced without requiring such specific details. In other instances, well-known methods, procedures, and components have not been described in detail so as not to obscure the examples defined by the claimed subject matter.

Some portions of the detailed description that follow are presented in terms of flow chart processes, algorithms and/or symbolic representations of operations on data bits and/or binary digital signals stored within a computing system, such as within a computing platform and/or computing system memory. These descriptions and/or representations are the techniques used by those of ordinary skill in the data processing arts to convey the substance of their work to others skilled in the art. A flow chart process and/or algorithm is here and generally considered to be a self-consistent sequence of operations and/or similar processing leading o a desired tangible result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Though these descriptions are commonly used in the art and are provided to allow one of ordinary skill in this field to understand the examples provided herein, this application does not intend to claim subject matter outside of the scope of 35 U.S.C. 101, and claims and claim terms herein should be interpreted to have meanings in compliance with this statute's requirements.

Unless specifically stated otherwise, as apparent from the following discussion, it is appreciated that throughout this specification discussions utilizing terms such as “processing”, “computing”, “calculating”, “determining”, “identifying” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that instructs may mean to direct or cause to perform a task as a result of a selection or action by a user. A user may, for example, instruct a computing platform to embark upon a course of action via an indication of a selection, including, for example, pushing a key, clicking a mouse, maneuvering a pointer, touching a touch screen, and/or by audible sounds. A user may, for example, input data into a computing platform such as by pushing a key, clicking a mouse, maneuvering a pointer, touching a touch pad, touching a touch screen, acting out touch screen gesturing movements, maneuvering an electronic pen device over a screen, verbalizing voice commands and/or by audible sounds.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure. To this end, many well-known techniques and design choices are not repeated herein so as not to obscure the teachings of this disclosure. Those of ordinary skill will appreciate that there are many ways to code functionality described in flow charts in many various computing languages and using various computing protocols. Claimed subject matter is not intended to be limited to a particular computer language or coding of the processes and subject matter described herein. Those of ordinary skill will appreciate that functionality or steps described in flow charts may be implemented using different orders of steps or actions from those specifically shown in the flow charts, unless specifically stated otherwise. Those or ordinary skill will appreciate that flow charts may not include all processes that may be used within the scope and spirit of the present application, but merely provide single examples of one manner of practicing the subject matter disclosed herein. Other processes and/or additions to processes disclosed are possible within the scope and spirit of this application.

Throughout this specification, the term system may, depending at least in part upon the particular context, be understood to include any method, process, apparatus, and/or other patentable subject matter that implements the subject matter disclosed herein.

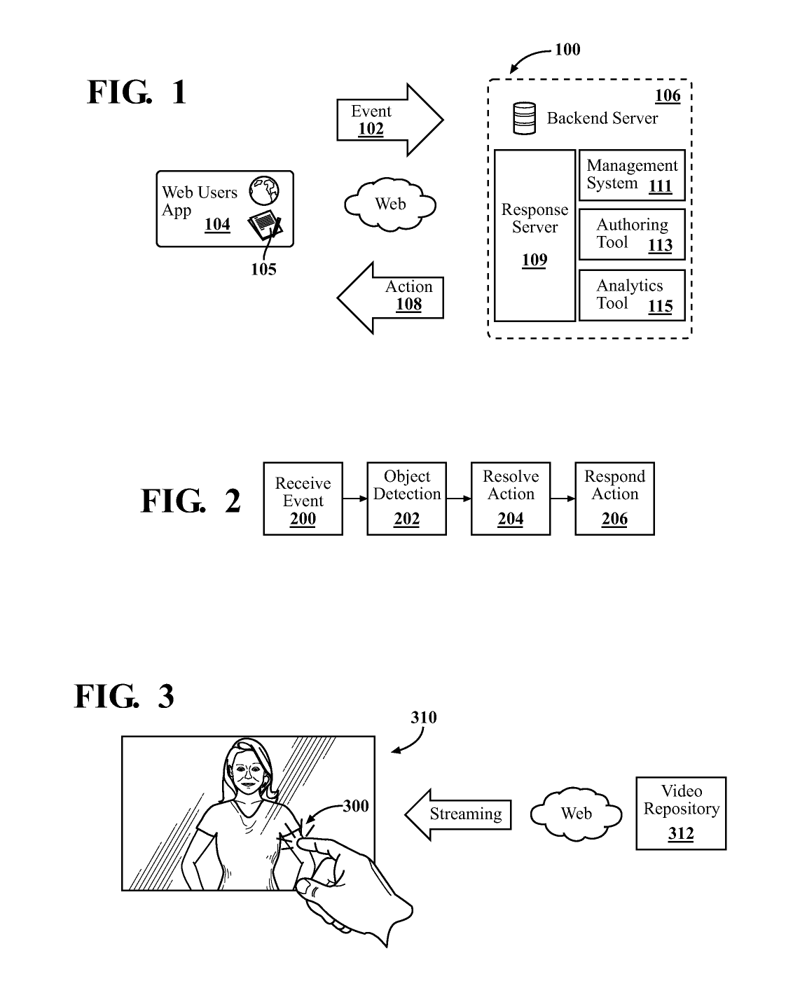

As shown in FIG. 1, system 100 may receive event 102 from a web based user application (or app) 104. Web user app 104 may be a client, viewing user or other user. There may be one or more web users with web user app 104. The system 100 includes a web portal 105 with a graphical user interface (GUI) that may be displayed by web user app 104, such as a web browser or application. Web portal 105 may be viewable with a standard web browser, such as Internet Explorer®, Mozilla®, Safari® and/or Chrome®. Web portal 105 may be HTML 5 based in at least one example. Web user app 104 may access system 100 by a computing platform, such as but not limited to, a mobile device, tablet, desktop or laptop computer, and others known in the art. The computing platform may operate with various operating systems known in the art, such as but not limited to, Microsoft Windows® or mobile device operating systems, Apple® operating systems, Android™ operating systems, and the like. An example computing platform is described herein below, though claimed subject matter is not intended to be limited in this regard.

Event 102 may be any user action that may trigger event-driven content to be displayed on web portal 105. Event 102 may include a mouse-click, mouse-over, touching a touchscreen, a keystroke or keyboard typing, other data input, generating a specific sound or speech, among many other possibilities of user actions that may be performed. Event 102 is communicated to system 100 through the web portal 105 through, but not limited to, HTTP/HTTPS protocols. For example, upon viewing a visual marker on web portal 105, web user using web user app 104 may click a mouse upon the visual marker. This mouse click event 102 may be communicated to system 100 via web portal 105.

System 100 includes a backend server 106. Backend server 106 may provide business rules, response rules, instructions and/or pointers for client side creation of event-driven content, client side enabling event-driven content upon one or more video, audio and/or picture source files, and/or playing of event-driven content enabled upon source files, Backend server 106 may include a database that is adapted to store the business rules, response rules, instructions and/or pointer data.

Backend server 106 may comprise a response server 109, a management system 111, an authoring tool 113 and an analytics tool 115. Response server 109 may be adapted to receive one or more events 102 from clients and/or computing platforms of web users 104. Management system 111 may be adapted to manage creation, editing and/or deleting of video, audio, picture, Clixies™, visual markers and/or social Authoring tool 113 may be used by an author web user app 104 for generating event-driven, mark positions and/or timings within a source video for event-driven content, and/or placing one or more visual markers within a source video, audio and/or picture file during its display and/or playing. Analytics tool 115 may be adapted to capture, store and display data associated with event 102. As such, the present system 100 includes server side processing for event-driven content, as opposed to client side processing of encoded embedded event-driven content that is packaged on the server side and sent to the client side for executing.

Response server 109 may be a HTTP server, such as but not limited to, an Apache™, Tomcat™ and/or Java® server. There may be more than one response server 109 in various examples. Response server 109 may include multiple response servers and as such, may be escalated and adapted to respond to multiple users 104 and receipt of multiple events 102. Response server 109 may comprise multiple response servers 109 in one server and/or across multiple servers.

Response server 109 may process event 102. In response to receipt of event 102, response server 109 may process event 102, and an action 108 may result. Action 108 may be communicated to web user app 104 via web portal 105. Action 108 may include display of interactive content pieces (such as Clixies™) on web portal 105.

Backend server 106 also may optionally contain an analytics tool 115 and/or a tracking application that is adapted to record, gather, assess, and/or report events 102. The analytics tool 115 may gather, assess, organize and/or report analytical data about web user app 104, including user behavior using web user app 104, geographic location, user actions (events 102), timing of events 102, order of events 102, whether an event 102 produces an action 108 to display Clixies™, and/or whether an event 102 does not produce an action 108, such as if a web user 104 clicks upon an area that is not associated with an event and/or does not have event-driven content.

For example, the analytics tool 115 may record and analyze metrics data including but not limited to, where/when a web user app 104 accesses or views objects, video play/stop/pause information; order of event 102 interaction; “false click” information (where a web user app 104 attempts to click on an image/object even if there if not any event-based content in that position on the GUI of web portal 105 at the time of the selection); and/or web user app 104 click through to one or more third party websites (such as to purchase items placed in the event-driven content of a source file. Data may be exported from the system 100 into other backend systems and reporting tools (i.e. Google® analytics), such as to assess user click-through, and/or data may be imported from third party sites regarding activity on the third party site, to report via the user metrics reporting functionality of the present system.

In some examples, functionality for tracking user activity may include tracking for purchases—when a web user app 104 is using system 100, system 100 automatically logs the web user app 104 in and assigns a unique user ID key to follow the web user app 104 fir transactions for reporting. A web user app 104 may receive a unique URL for accessing system 100, which also may be used for tracking transactions for reporting. Tracking may be accomplished based upon receipt of one or more events 102, as described with reference to FIG. 2. System 100 may integrate with third party sites via the event-driven content by sending event 102 information and/or web user app 104 data to the third party website, including the unique ID to track the web users purchase. APIs of system 100 may plug into one or more third party systems. System 100 may include one or more published APIs that are integrated by the backend server 106 based upon the business rules.

System 100 may optionally include dual reporting functionality, including functionality for receiving data from a third party site (such as but not limited to purchases made, tracking, user behavior with site content after a purchase), and information reported to the third party site by system 100. System 100 may learn one or more behaviors of one or more web user apps 104 from third party sites based upon third party monitoring, and receive the third party monitoring information. System 100 may optionally include functionality for reporting on the third party data.

FIG. 2 shows an example of the method that response server 109 uses to process an event 102. As shown at block 200, response server 109 receives event 102. As described above, event 102 may be communicated through the Internet and response server 109 is adapted for receiving event 102 from web-based communications via HTTP/HTTPS. When event 102 is received, system 100 registers the event. One or more or all events 102 may be registered in a registration log of system 100. At block 200, system 100 may detect web user app 104 based upon identifying data such as an IP address and/or unique user id, and/or determine the object detection mechanism based. upon an event type of event 102.

At block 202, response server 109 performs object detection using the object detection mechanism for the particular went type. Object detection is determination of whether the event 102 was generated in a previously defined position. For example, if the event 102 was a mouse click selection by web user 104 on a position within the video during playing that did not have event-driven content, the object detection would detect that event 102 was not generated in a previously defined position within the video file during play. For example, if the event 102 was a touch on a touch screen by web user 104, on a visual marker, the object detection would detect that event 102 was generated in a previously defined position during video play. Object detection may be based upon positioning of one or more event areas enabled upon the video file playing area that is displayed in a time-based manner during video play.

FIG, 3 shows an example event area 300. When the web user app 104 creates an event 102, all events 102 are sent to backend server 106. Event area 300 is enabled for video playing area 310. Video playing area 310 displays video streamed from video repository 312, which is external to backend server 106 (FIG. 1). Upon receipt of event 102 upon event area 300, system 100 uses event area 300 to analyze event 102, based upon the specific video defined information incorporated into the source video, such as video duration, video height and/or video width during playing, and other video specific information may be used. The management system 111 supplies specific code to be inserted into the webpage or apps where the video/audio/image to send event 102 to system 100 and generate action 108. in at least one example, event area 300 may be inserted by instructions from system 100 over video playing area 310, which is a HTML 5 video player. System 100 may include one or more APIs to access the response server.

Event-based content may be displayed based upon an event 102 being captured within event area 300. Interactive content pieces (such as Clixies™) and/or visual markers may be displayed inside and/or outside of event area 300. Event-driven content may include multiple types of content for a single event 102. The event-driven content may be edited and/or changed without having to recode the source video, audio and/or picture file, because there is not any embedded pre-coded event-driven content upon the source file. The event-driven content may be different for different web users using web user app 104 for a particular source file, based upon the business rules, response rules, instructions and/or pointer data. For example, a single source video may be displayed with event-driven content of different languages, based upon a geographic location of a web user app 104 viewing the source video, based upon the business rules of the backend server 106.

Referring to FIG. 2, event 102 may possess various properties for different types of events 102. These may be used for object detection at block 202. For example, event 102 may be a click-through event where a web user using web user app 104 clicks upon or otherwise selects event-driven content enabled upon a video file. There may be one or more areas defined within the video file viewing area for the click-through event. A click-through event may direct a web user app 104 to a new website, such as but not limited, a third party website or webpage.

Event 102 may be a video click event. There may be one or more areas defined within the video file viewing area for the video click event, which is an event-driven content sensitive area. The video sensitive area may be defined by a video-ID variable, which is an identifier for the source video file. The video sensitive area may be defined by an event-type identifier, which is an identifier indicating the type of event 102. The video sensitive area may be defined by a video-width and/or video-height, which is data for the width and height of the video sensitive area and/or video playing area during web user 104 playing of the video file. The video sensitive area may be defined by a x-coordinate and/or y-coordinate, which is data for one or more positions within the video sensitive area and/or video playing area during web user 104 playing of the video file. The video sensitive area may be defined by one or more time-of-click variables, which include data for the timing of the event 102 during playing of the video file. A video sensitive area may be defined by one or more of and/or various combinations of the variables described herein. Of course, events 102 may be audio and/or picture events and this system 100 is intended for use with video, audio and picture source files.

Event 102 may be a video start event, which indicates that web user 104 has started play to the source video file, such as by selecting a start button on a video player or viewing application. A video start event may be determined based upon the video-ID identifier and event-type identifier. Similarly, event 102 may be a video pause event and/or a video stop event, which may communicate that web user app 104 has paused and/or stopped play of the video file. A video pause and/or video stop event may be determined based upon the video-ID identifier and event-type identifier.

Event 102 may be a picture click event. A picture click event is an event indicating that web user using web user app 104 has selected a picture within the sensitive area. A picture click event may be based upon a picture-ID identifier that identifies the picture, the event-type identifier, a picture width and/or picture height identifier that identifies the width and height of the picture, and/or an x-coordinate and/or y-coordinate identifier indicating the position of the event within the picture.

Event 102 may be audio start event. An audio start event may be selection by web user app 104 to start the playing of an audio file. It may be defined within timed marks by an audio-id identifier that identifies that audio file, the event-type identifier, and/or the time-of-click identifier. Similarly, event 102 may be an audio pause and/or audio stop event, indicating selection by web user app 104 to pause and/or stop playing of the audio file.

Event 102 may be a timed event. For example, a user authoring an embedded video may cause an event to occur at a specific time during video play. The timed event occurring at a specified time during video play may be that a Clixie™ appears at a specified time. For example, a Clixie™ for Coca-Cola® may be set to appear at exactly 2 minutes and 36 seconds into the video, to coincide with the video displaying a Coke® can. Or, it could also coincide with an actor saying the word (audio) “Coke” at 2 minutes and 36 seconds in the video.

Event 102 possesses inherited properties. For example, an inherited property is an IP address of the computing platform of the web user app 104 generating the event 102. For example, an inherited property is a unique user identifier, which is a calculated or programmer unique user id to identifier distinct web user apps 104. For example, an inherited property is an event time stamp, which is a general server-wide time stamp indicating that time of event 102.

Event 102 possesses calculated properties that are based upon event properties and inherited properties. For example, event 102 has a Geo Location that is calculated based upon the IP address of web user app 104. For example, event 102 has a local time that is calculated based upon the IP address of the web user app 104 and the Geo Location for that web user using web user app 104.

At block 204, one or more actions 108 are resolved for the event 102. System 100 is adapted to have multiple responses or actions 108 to a single event 102, based upon the business rules, response rules, instructions and/or pointer data, where an event 102 has multiple conditions. On the other hand, multiple events 102 may generate the same response or action 108. In this manner, the responses or action(s) 108, and the event-driven content may be changed for a source video, audio and/or picture file, based upon applying one or more different business rules, response rules, instructions and/or pointer data.

Actions 108 may include predefined responses to events 102, based upon event type. They may be based upon one or more business rules, instructions and or data stored in the management system 111 of backend server 106. After the object has been detected at block 202 or if the object has not been detected at block 202, at block 204, calculated properties for event 102 are generated and a response to event 102 is determined. Calculated properties may include geo-location. Calculated properties are generated by business rules held in the backend, related to the viewer's IP address. More than one response to event 102 may be determined. Action 108 is the response(s) to event 102 generated by system 100.

Action 108 may include, for example, generating a display, where system 100 generates instructions for event-driven content to be displayed on the GUI of web portal 105. The event-driven content that is to be displayed with action 108 may be determined by the management system 111 of backend server 106 based upon one or more business rules, instructions and/or data. For example, based upon an inherit property of an event 102, such as the IP address of web user 104, management system 111 may determine which language to present the event-driven content in to the web user 104. For example, based upon receipt of a video play event 102, management system 111 may generate instructions for playing event-driven content based upon x-coordinate data, y-coordinate data and timing data (also known as the (x,y,t) data) for the source video being played on the computing platform of web user using web user app 104.

Action 108 may include generating ins ructions to page jump, or for the web portal 105 to jump to a specific URL or web page.

Action 108 may be based upon one or more business rules or response rules of The system also may access the physical location of the user based upon the user's IP address, and filter event content based upon the IP address location. For example, the content may be displayed in different languages based upon the point of access. Content display is based around the location of the user, (users may view the same video from the U.S. and Brazil, but the event-driven content may be displayed in English in the U.S. and Portuguese in Brazil). In this sense, the event content has the same interactivity, but because the system knows the users' geographic locations, and the event rules may include that it is based upon location, the content differs. Similarly, based upon the user's locations, different locations or local retailers may be included in the event content displayed for a particular user.

Various system 100 examples may include business rules that require a user to select interactive objects in a particular order. Various system 100 examples may include business rules that require the user to watch the entire video prior to making any of the content interactive.

Response rules may comprise event dependent actions, which are actions that will occur based on previously generated events 102. For example, an action 108 may be defined for a certain number of like events 102, such a but not limited to, clicks (first 500 clicks received get a 15% coupon), then after that, more clicks give a different coupon or no coupon, or there may be a price change for a product included with the event based content.

Response rules may include time dependent actions, which are actions 108 that will only occur at one or more specific times. For example, a time dependent action may include generating instructions to display event-driven content on the sensitive area 300 of web portal 105 at a pre-determined time after receipt of a video play event 102.

Response rules may comprise geographically dependent actions, which are actions 108 that result only if a web user using web user app 104 is located within a specific geographic location, as determined based upon the IP address inherited property of an event 102. For example, for a web user app 104 located in Mexico, action 108 may include instructions for generating event-driven content identifying a third party retailer located in Mexico, but action 108 instructions generated for web users using web user app 104 located in the United States would not include this event-driven content. Instead, system 100 may generate instructions for providing event-driven content identifying a retailer located in the United States for such web user apps 104.

Response rules may comprise counter dependent actions, which are actions 108 that may result if video play of a source video is within a specific number of events 102. Management system 111 of system 100 may include a counter that is adapted to track the number of events 102 received by system 100 from a particular web user app 104.

In this manner, the action 108 content may be event 102 driven, geographically driven, based upon user data, or time-based driven, based upon business rules of the backend server, for selecting which content of an event to display for a particular user.

Action 108 may also include open page, launch applications, or play video. Many more actions 108 are possible within the scope and spirit of this application.

Management system 111 (FIG. 1) may further comprise a registration log. Event 102 may be recorded in the registration tog. Action 108 may be recorded in the registration log. Both event 102 data and action 108 data may be stored in the registration log and/or used by the analytics tool 115 or tracking application of backend server 106 for analyzing web user app 104 behavior and providing system use statistics, such as but not limited to, event-driven content use and false clicks within a video where a user seeks event-driven content but it is not provided. These are optional features of system 100.

Referring to FIG. 2, at block 206, the respond action 108 is communicated or transmitted to the client, or the computing platform by web user 104 by response server 109. This provides instructions for generating and/or playing event-driven content enabled upon the source video. At block 206, an event ID may be generated, which is a unique identifier that may be used to identify the event 102. It may be used by the analytics tool 115 and/or for tracking or reporting functionalities of system 100.

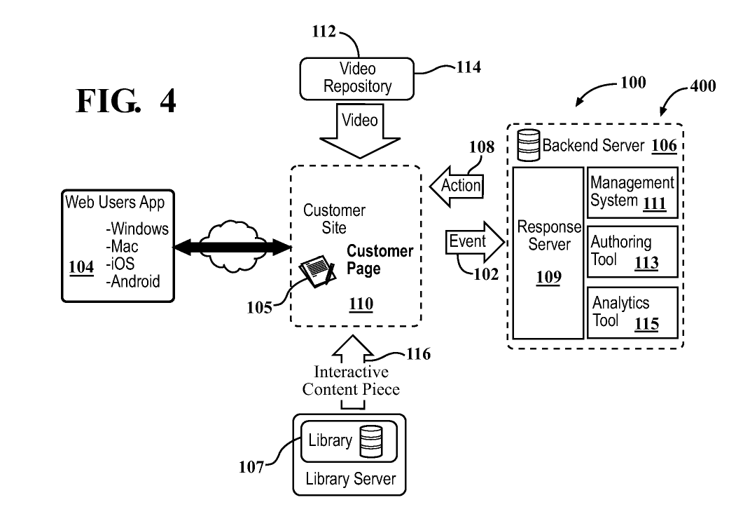

A second example system is shown in FIG. 4. In this example, customer webpage 110 on a customer website is in remote communication with web user app 104. Customer webpage 110 is in remote communication with system 400. One or more events 102 may be communicated from customer page 110 to backend server 106. One or more actions 108 may be communicated from backend server 106 to customer page 110. Backend server 106 may provide business rules, instructions and pointers for client side creation of event-driven content, client side enabling of event-driven content upon one or more video files and/or playing of event-driven content enabled for video files. In this example, web portal 105 may be viewed by web user apps 104 as part of customer page 110. The web portal 105 on customer page 110 may be HTML 5 based and/or mobile device application in at least one example.

In this example, system 400 includes a library 107 of interactive content pieces 116 (such as Clixies™) and/or visual marker data. Library 107 may comprise one or more databases of interactive content pieces (116 such as Clixies™) and/or visual marker data (such as the URL data described above), instructions for retrieving one or more interactive content pieces 116 (such as Clixies™) and/or visual markers from memory, instructions for retrieving video files from memory, and/or in some examples library 107 may include event-driven content. Interactive content pieces 116 may be communicated to customer page 110 for viewing upon web portal 105. Library 107 may be a remote or cloud-based storage for storing interactive content pieces 116, that is separate from backend server 106, such as a third party controlled storage and/or a publicly accessible storage. Backend server 106 may provide instructions for accessing one or more interactive content pieces 116 from library 107 for creating and/or playing event-driven content enabled for a video file 114 stored in video repository 112.

The example in FIG. 4 also includes a video repository 112, which may comprise one or more databases or memory for storing video files. Video repository 112 may be a remote or cloud-based storage for storing video files 114, that is separate from backend server 106, such as a third party controlled storage and/or a publicly accessible storage. Backend server 106 may provide instructions for accessing one or more video files 114 from video repository 112 for creating and/or playing event-driven content enabled for a video file 114 stored in video repository 112. Web users using web user app 104 may view video files 114 from video repository 112 on customer page 110. As such, video repository 112 is in communication with customer page 110. Video repository 112 may be in remote communication with system 400 and/or backend server 106, for creating event-driven content. Backend server 106 does not store video files 114, nor change their file format or content. Video 114 may be stored on and/or streamed from video repository 112, which may be any server or device in a cloud based repository that is compatible with an integrated video player. In one example, the integrated video player may be an HTML 5 video player.

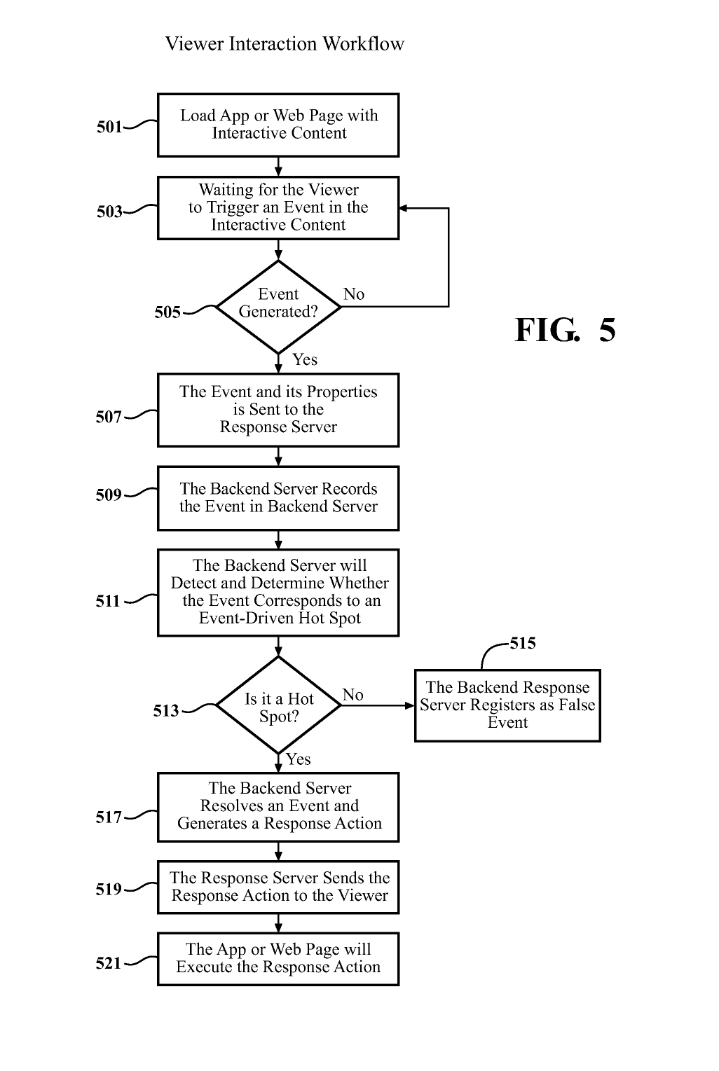

FIG. 5 illustrates an example method of displaying event-driven content for a web user app 104, by system 100 and/or system 400. Block 501 illustrates that system 100 or 400 loads an application or web page with event-driven content to web portal 105. At block 503, system 100 or 400 waits for receipt of an event 102 from web user app 104 via an event area 300 on the GUI of web portal 105. If an event 102 is generated at diamond 505, the event 102 and its properties are sent by system 100 or 400 from web portal 105 to response server 109, at block 507. If an event is not generated, system 100 or 400 remains at block 503.

Block 509 illustrates that the backend server 106 records the event 102 in a registration log of backend server 106. At block 511, backend server 106 analyzes the event 102 and determines whether the event 102 corresponds to an event-driven “hot spot” on event area 300 (FIG. 3). If it not a hot spot (as determined at diamond 513), a false event is detected at block 515 and backend server 106 registers it as a false event. The false event data may be recorded in the registration log.

At block 517, system 100 or 400 resolves the action 108 correlating to the event 102 (as described with reference to FIG. 2 above). Action(s) 108 are sent by response server 109 of system 100 or 400 to web user app 104 via web portal 105 at block 519. At block 521, the one or more response actions 108 are displayed upon the web portal 105.

FIG. 6 illustrates an example of backend server 106. Backend server 106 may be used to tangibly embody one or more methods described with respect to FIGS. 1-5. Backend server 106 may include a processor and/or memory and is capable of web-based or other remote communication with one or more computing platforms of web users using web user app 104. Backend server 106 may be in local and/or remote communication with one or more repositories and/or databases. The processor of backend server 106 may be capable of executing electronically stored instructions to perform one or more methods described with respect to FIGS. 1-5.

Server 606 has one or more processors capable of performing tasks, such as all or a portion of the methods described with respect to FIGS. 3-5, as described herein. Server 606 is in communication with and/or has integral memory in one or more examples. Memory may be any type of local, remote, auxiliary, flash, cloud or other memory known in the art. In some examples, one or more user devices or other systems may send data to response server 109 via a network for storage in memory, such as database information for one or more of databases in independent database layer 606, or other information.

This example includes applications layer 602, which may contain one or more software applications that backend server 106 may store and/or that may be executed by a processor of backend server 106.

Backend server 106 further comprises a server layer 604, which includes response server 109. Server layer 604 is responsible for communications of events 103 and actions 108, between backend server 106 and web user apps 104, via the GUI and/or event area 300 of web portal 105. Server layer 604 may include a web server, which may be used to communicate with one or more computing platforms and/or user devices remotely over a network. Communication networks may be any combination of wired and/or wireless LAN, cellular and/or Internet communications and/or other local and/or remote communications networks known in the art.

Backend server 106 further contains an independent database layer 606, which is adapted for storing business rules, response rules, instructions and/or pointer data for enabling event-driven content upon source video, audio and/or picture files. The independent database layer 606 may include a rules database for storing business rules, response rules, instructions and/or pointer data for use in generating event-driven content enabled upon a source file. Independent database layer 606 may comprise multiple databases. Those skilled in the art will appreciate that database structure may vary according to known techniques.

Applications layer 602 may include one or more applications that backend server 106 is capable of executing. For example, applications layer 602 may include a localization module 608, which is a module adapted for handling multi-language scenarios. Applications layer 602 may include delayed jobs module 610, which is a module that handles asynchronous processes and jobs. For example, statistics generation. Delayed jobs module 610 is adapted to trigger action 108 processes that do not require events 102 and that do no require immediate responses. An example of this would be statistics generation.

Applications layer 602 may include email services module 612, which is a module that is adapted for handling communications to users. Email services module 612 may be adapted for generating electronic communications for sending to users, including email, SMS, phone, and other types of electronic communications are possible.

Applications layer 602 may include video processing module 614, which is a module that generates preview strips or thumbnail files for one or more source video files. It does this by calculating the number of transitions based on video length, then creating snapshot images based on the time marks contained within the video. Depending on the length of the video, the system may generate two preview strips to allow the user to move easily between multiple snapshots.

Applications layer 602 may include reporting module 616, which is a module that generates and displays statistics and graphics information regarding all events and viewer behavior. For example, it places viewers on a graphical map of the world, showing their location to within 50 miles. It does this by logging the viewer's IP address, comparing it to a database that contains the geo-location of all IP Addresses, then matches the IP to the viewer's physical address.

Applications layer 602 may include web services module 618, which is a module that handles in/out (bi-directional) communications to the backend server by a user 104 via web portal 105. It does this by an HTTP or HTTPS protocol. Examples of web services module 618 may include an XML, and/or json based communications module.

Applications layer 602 may include full text engine module 620, which is a module that is a full text indexer for managing more efficient search mechanisms. It provides a simple way to find videos, interactive content pieces (such as Clixies™) and visual markers that contain specific text. For example, a user could search for all items that contain the word “sun.”

Applications layer 602 may include authorization rules module 622, which is a module that handles levels of user access, based on privileges and business rules.

Applications layer 602 may include authentication module 624, which is a module that handles authentication of web users 104, including log-in access for web users 104. It does this by handles authorization requests based on login credentials stored in the backend.

Applications layer 602 may include geo-detection module 626, which is a module that may transform IP address data into geographic location mapping. It does this by logging the viewer's IP address, comparing it to a database that contains the geo-location of all IP Addresses, then matches the IP to the viewer's physical address.

Applications layer 602 may include event analyzer module 628, which is a module that detects events 102 during source file play and performs the tasks described in FIG. 2, for responding to events 102 with one or more actions 108.

Applications layer 602 may include event aggregator module 630, which is a module that summarizes large quantities of events 102 and may prepare aggregate responses to events 102, for a more efficient reporting response.

Applications layer 602 may include object detection module 632, which may be called by event analyzer module 628 for detecting the type of event 102 received by response server 109. Object detection module 632 may analyze a click or other user selection event, to determine whether the event appeared on an event-driven content “spot” upon predetermined event area 300, based on a polygon form.

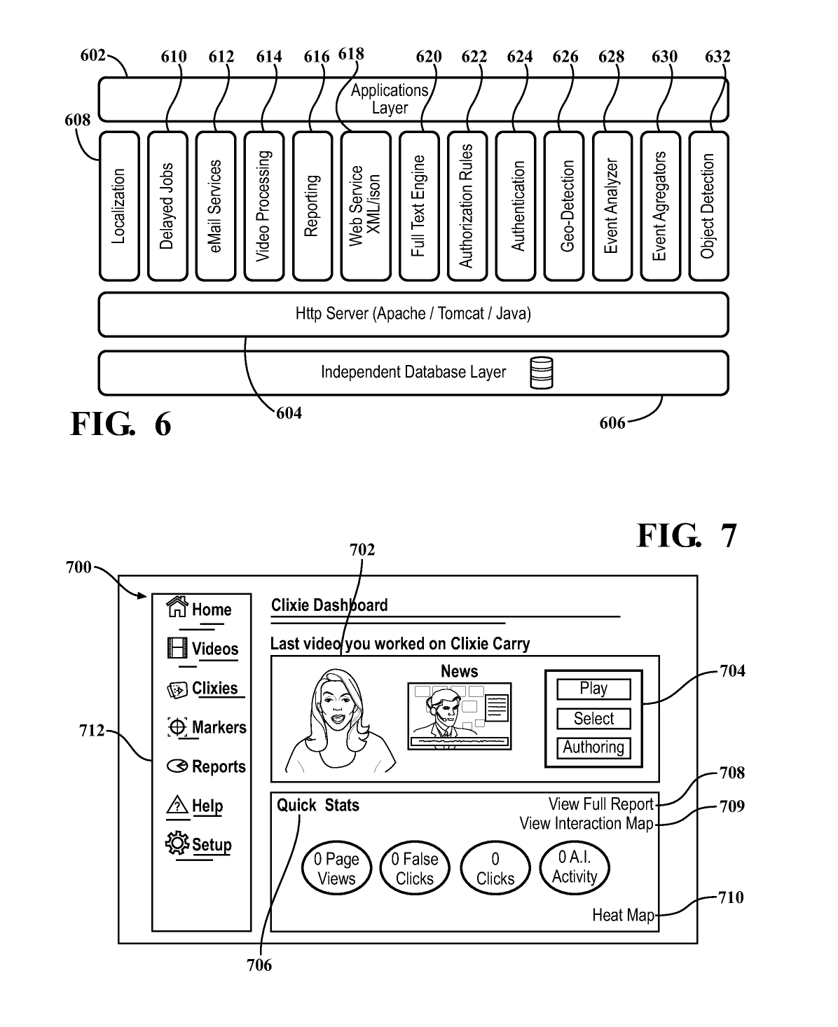

FIG. 7 illustrates an example GUI 700 for authoring tool 113. After a web user app 104 logs onto system 100 or 400, GUI 700 may be displayed. GUI 700 includes a dashboard for the authoring tool 113. Field 702 is for displaying data regarding the last video that a user worked on. There is a video options field 704, which includes functionality that may be selecting fur playing, selecting and/or accessing authoring editing controls for the video displayed in field 702. The video is played upon selection of the “Play” button in field 704. Video options, such as play, edit link, delete, sample, process and authoring may be viewed upon selecting the “Selecting” button in field 704. By selecting the “Authoring” button in field 704, the event-driven content may be edited and authoring controls are accessed.

GUI 700 includes a Quick Stats field 706, which may display quick statistics for the video displayed in field 702. Statistics may include page views, false click data, hot spot selection data, all user activity regarding the video, and other statistics or data regarding the video may be displayed in field 706. Quick Stats field 706 may include URI functionality for viewing one or more reports regarding the video (URI 708), functionality for viewing an interaction map identifying locations where users have attempted to select interactive items upon the video display (URI 709), and/or a heat map for the video (URL 710). GUI 700 may include a navigation tool bar 712, for accessing various features of authoring tool 113, such as but not limited to, video projects for accessing indexed content (“Videos” button), accessing indexed interactive content pieces (such as Clixies™) (“Clixies” button), accessing visual markers (“Markers” button) that indicates event-driven content is enabled, reports (“Reports” button), and the like.

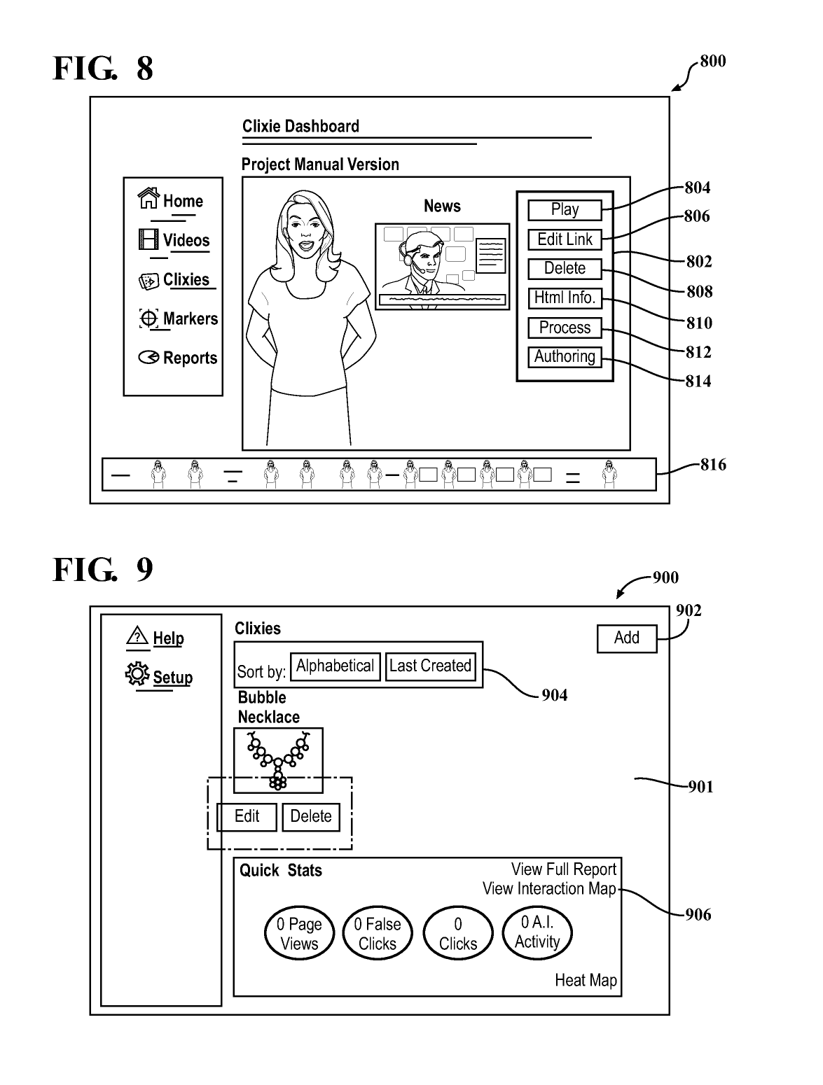

FIG. 8 illustrates an example GUI 800 that may be displayed if a video is selected from the video library. GUI 800 is a project page view of summary information about the video. With GUI 800, a web user app 104 may play a video, edit a video or other actions.

In order to create a new video project, web user using web user app 104 enters a name for the video project and a URL identifying where the source video file is located from the video library 107 (FIG. 400). If a source video is subsequently moved, the URL would need to be updated.

GUI 800 includes project control field 802, for accessing functionality for authoring the event-driven content. Control field 802 includes a “Play” button 804 for playing the source video file. Control field 802 includes an “Edit Link” button 806 for editing the name and/or URL data for where to find the source video file. Control field 802 includes a “Delete” button 808 which may be used to delete the entire video project, including data for locating the source video and the event-driven content overlaying upon it. Control field 802 includes “HTML Info” button 810 that provide the data required to publish the video on a website. Control field 802 includes “Process” button 812, which may be selected to access data about the video captured when the video is processed into the backend, such as length, format and size. Control field 802 includes “Authoring” button 814, which may be selected for editing the event-driven content enabled upon the source video.

GUI 800 includes timeline bar 816, which displays different thumbnail video images of the source video file over time.

Authoring tool 113 may include video controls on one or more GUI displays, for starting, pausing, stopping, rewinding, forwarding, jumping to the beginning of the video, jumping to the beginning or ending of an event-driven content piece played during the video, for advancing or retreating a pre-set time period (such as 0.25 seconds), playing the video in slow motion, or other controls that may be used in creating or editing the event-driven content.

FIG. 9 illustrates an example GUI 900 that may be displayed if the “Clixie” button of toolbar 712 is selected. GUI 900 includes afield 901 for displaying a library of existing interactive content pieces (such as Clixies™) that are associated with the video. The library file data may be stored in and accessed from library 107 (FIG. 4). GUI 900 includes an “Add” button 902 which may be selected to associate an interactive content piece (such as a Clixie™) to the video from library 107. Field 904 includes controls for alphabetically displaying the library files field 901, and/or sorting the library files by when they were last updated. GUI 900 includes a Quick Stats field 906, similar to that described with reference to FIG. 7.

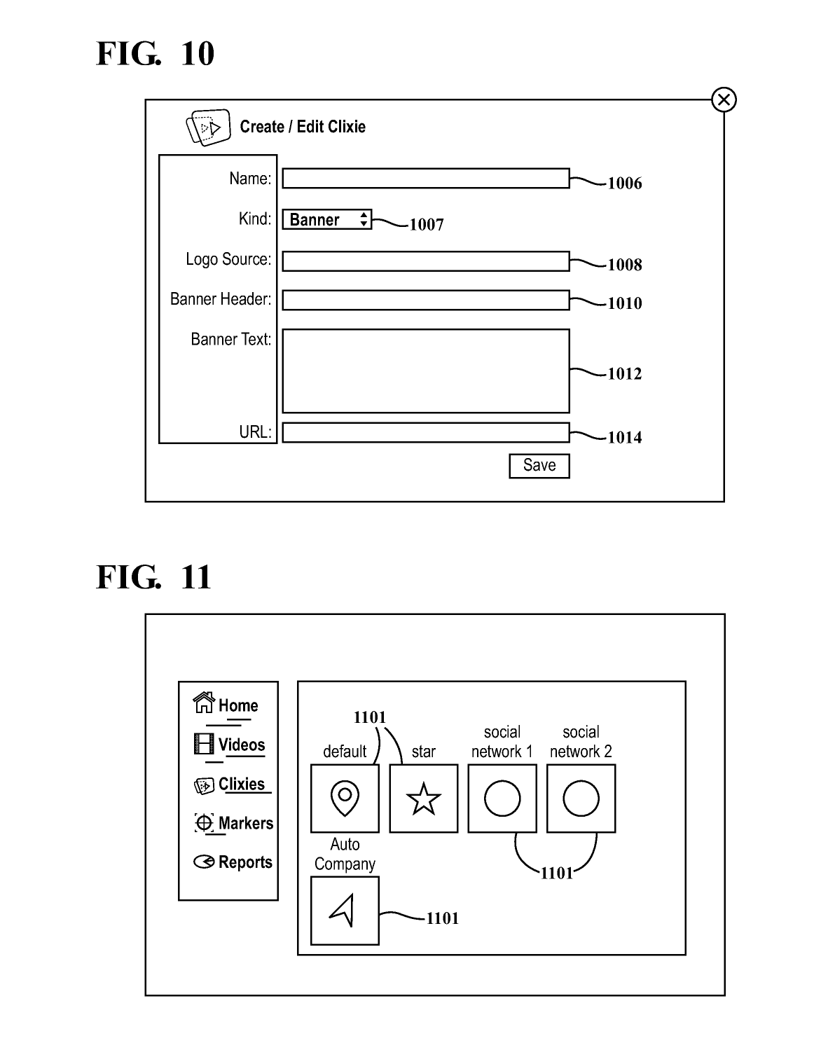

FIG. 10 illustrated an example GUI 1000, which an author web user 104 may use for creating anew interactive content piece (such as a Clixie™). To create anew interactive content piece (such as a Clixie™), an author using web user app 104 may enter the Clixie™ name in field 1006. The name is stored in library 107 (FIG. 4). Web user using web user app 104 may select a type or kind of action to be created in field 1007. This particular example of field 1007 comprises a pull down menu, but other example displays are possible. The pull down menu ma list different types of content. For example, the interactive content piece (such as a Clixie™) may be a “banner” for display, a click through to a third party website, and other types of content are possible. Banner content may include an interactive content piece (such as a Clixie™) that may be placed to the top left, right or bottom of the video playing area, as selected by a Thor web user app 104. A viewing web user app 104 may click upon the interactive content piece (such as a Clixie™) during or after video play to be directed to a URL to view the content. The interactive content piece (such as a Clixie™) may be associated with a visual marker. The kind selected in field 1007 may be “Click-through.” Click-through content may automatically and immediately redirect a viewing web user on web user app 104 to the embedded URL, once selected. Of course, this example pertains to Clixies™, but many other interactive content pieces are contemplated within the scope and spirit of this application and claimed subject matter is not so limited.

To create the new interactive content piece (such as a Clixie™), an author web user using web user app 104 identifies in URL field 1014, the source for where the where the web user app 104 is taken when clicking on the interactive content piece (such as a Clixie™). This location data comprises a URL and is stored in library 107 (FIG. 4). If the web page is moved ort becomes inactive, the URL needs to be edited. The interactive content piece (such as a Clixie™) may include a banner header field 1010, which is a name for the interactive content piece (such as a Clixie™) that the viewing web user app 104 will view. It may include a banner text field 1012, which is a field for a brief description of the interactive content piece (such as a Clixie™) that the viewing web user using web user app 104 may read. An author using web user app 104 also identifies a URL for the web location for where the image file is located in the Logo source field 1008. This URL data is stored in library 107 (FIG. 4). One or more social links (not shown) may also be added to the interactive content piece (such as a Clixie™) such as Facebook®, Twitter®, Instagram®, Tumblr® or other social media access buttons that may be selecting by a viewing user using web user app 104 to allow a web user using web user app 104 to share the interactive content piece (such as a Clixie™) and/or video.

Authoring tool 113 uses object identification enabling for the source file to provide informational content to web user apps 104 as an interactive content piece (such as a Clixie™). The interactive content piece (such as a Clixie™) may be viewable during the playing of a source file and/or a web user app 104 may play the source file uninterrupted and click-through the interactive content piece (such as a Clixie™) at the end. Authoring tool 113 may include tagging controls for use in tagging one or more items or objects in a video source file, for adding interactive content piece (such as a Clixie™). Tagging controls may include a square shape button (for tagging an item with a square shape upon the event area 300), a round shape button (for tagging an item with a round shape upon the event area 300), and/or a spline shape button for free-hand drawing a shape for object tagging. Tagging controls may include a visual marker button for displaying what object in the video is associated with an interactive content piece (such as a Clixie™). Other tagging controls are possible.

FIG. 11 illustrates that authoring tool 113 includes functionality for generating visual markers 1101, which may be assigned to one or more interactive content piece (such as a Clixie™) to inform a viewer that an object is event-enabled. A visual marker 1101 may be selected using the authoring tool 113, and the author user may set the visual marker 1101 image, location and duration of appearance during it e source file play. For example, a visual marker 1101 may appear over a target object by a pre-set duration. Visual marker 1101 display may be independent of user selection actions, which may trigger one or more events 102.

As shown in FIG. 11, various visual markers 1101 may be selected by an author using web user app 104. Visual markers 1101 may consist of pre-set images and/or in some examples, authors using web user app 104 may draw or provide their own visual marker 1101 images. Authoring tool 113 allows for placement of visual markers 1101. The visual markers 1101 may be based upon three dimensional by (x, y, time) coordinates. As such, for each visual marker 1101, a duration may be designated for when during the video the visual marker 1101 appears, as well as in which (x,y) location(s) the visual marker 1101 is to appear for each such duration. The visual marker 1101 may be displayed over the top of a video or picture image, or on the side of it. In various examples, a visual marker 1101 may be used to take a web user app 104 to a third party website by the web user using web user app 104 selecting an event area 300 at the location of the visual marker 1101 (touching it, clicking on it, etc.). The visual marker 1101 may be displayed on the video play area of the GUI of web portal 105. The authoring tool 113 may be used to create moving visual markers 1101, to follow object movement over time in a video.

In at least one example, an author may use the authoring tool 113 to create visual markers 1101 by drawing objects within a video, based upon a timeline displayed on the GUI of the web portal 105 (for example, FIG. 8 timeline 816). In one example, the GUI includes a timeline displayed at the bottom portion of the web portal 105 for displaying on a computing platform display screen. A web user using web user app 104 may select a visual marker 1101 and associate it with an object in the video. The visual marker 1101 for the event may be a pre-set shape (i.e., square, circle) and/or freehand drawn (spline) with points assigned to it. The assigned points may be unlimited. In at least one example, the authoring tool 113 automatically creates a timeline that is color coded in the GUI of the web portal 105, to that particular drawing of the object. (i.e. red dress—red bar on timeline to indicate duration that the “red dress” object will remain interactive in the video). An author user may edit the duration of the object event area by grabbing the timeline bar at the bottom of the display and dragging it to cover the desired duration.

Once the visual marker object 1101 is created, an author using web user app 104 may generate and/or identify an interactive content piece (such as a Clixie™) to be associated with it. The author using web user app 104 may select a visual marker 1101 and point it where she wants the visual marker 1101 to appear during the source file play (i.e. drag it over the dress displayed in the video). The system 100 or 400 may assign a color code to the object in the source file and that color appears on the GUI timeline for duration editing for the object display. The visual marker 1101 displays independently of the event duration (two durations are set). The interactive content piece (such as a Clixie™) may be linked to a public site and description text of the interactive content piece (such as a Clixie™), and/or a link for where the content is stored outside the system, and/or pictures and video content that are stored on the client side and/or remotely.

Visual markers 1101 may be automatically viewable at various times during video play and/or viewable in response to web user app 104 action, such as scrolling a mouse or other communications device over a display screen of the computing platform displaying the GUI of web portal 105. Examples of web user app 104 actions that may trigger making a visual marker viewable include, but are not limited to, mouse-click, mouse-over, touching a touchscreen in a spot, keyboard typing or other data input, generating a specific sound or speech, among many other possibilities of user actions that may be performed to produce a result.

During playing of a video having event-driven content, the video may continue to play, even if a user triggers display of interactive content piece (such as a Clixie™). Prior systems typically stop video play, while a separate web browser opens to display the content. At least one example of the present system includes continued video play, even if a user triggers an event or interactive content piece (such as a Clixie™). Visual markers 1101 display over the video during play and may also be displayed alongside the video, such as but not limited to, in a tool bar, for a user to access after the video play finishes and/or the visual marker is no longer being displayed during the video play.

A single visual marker 1101 may mark more than one interactive object or content. Interactive content pieces (such as Clixies™) may be filtered, based upon user data or other data, such that some but not all content is displayed for a particular user, upon the user triggering display of the interactive content piece (such as a Clixie™). For example, web user 104 may receive different interactive content piece (such as a Clixie™) in different languages based on their physical location, as determined by the web user app 104 IP address.

The interactive content piece (such as a Clixie™)may include content from a third party website, such as but not limited to, image content, text content, product information, product pricing information, and/or product sales/purchasing capabilities accessible via clicking through the interactive content piece (such as a Clixie™), to a separate third party website. Based upon the business rules, different content may be included for different users such that users in different geographic locations may be directed to different third party content or websites or HTML content. For example, different users may be directed to different product or sales information. For example, users in a specific geographic location may be presented with interactive content piece (such as a Clixie™) content for purchasing a product (and other users viewing the video that are not in the specified geographic region may receive interactive product information without having interactive purchasing functionality). Again, though a Clixie™ is used with an example of the present system to illustrate features and functionality of system 100 or 400, other interactive content pieces are contemplated within the spirit and scope of the present application.

The system allows for dynamic editing. It does not store video, interactive content pieces image or other content (apart from possible visual marker image content and/or text). Instead, it stores pointers, URLs or other link information for where such content is located (such as at third party locations supplied by author users). Specifically, the event data from the authoring tool is stored in the system, URL to the image and informational content of the interactive content piece, reference to the back end system for the (x,y,time) coordinates, and URL as to where the interactive content piece image is stored (third party website).

The authoring tool 113 also can view work in real time—as an author user tags a video with events for Objects, the system can track progress of work as how it will look for the viewers in real time. There is no need to generate a preview. There is no need to code or embed event-driven content upon a video file 112. The system does not deal with encoding, decoding, packaging, publishing video content to include the event-driven content. Because it does not do so, it allows for dynamic real time editing of event content. In order to add a new event to an existing video 112, an author use. need only edit the video 112 himself. Sending it to a third party for editing, encoding, decoding, and repackaging content is not required. in this manner, editing is dynamic—the system dynamically updates events associated with the video 112.

For event-driven content editing, because the author user tags an object or image that is moving in the video during play, and because the image tray change shape over a period of time, the image may be edited dynamically. For example, the object may follow a woman walking in the video wearing a red dress. The event area or “hot spot” for the dress may be adjusted over e in size (changing in the video due to motion (zoom in/out)), dynamically as the video plays. An author user does not have to change the shape frame-by-frame.

In at least one example, authoring tool 113 includes a slow play button in a tool bar, such as by way of example, at the top of the GUI, which may be used to grab the event area and follow the object as it is moving inside of the video (shrink it/make it bigger) as it moves. With the free hand drawing feature, irregular shaped objects may be created with multiple points. For example, if the woman in the red dress raises her arm the free-hand image for the red dress may be edited to accommodate the new shape created by the raised arm during the time period that the arm is raised, without having to re-draw a new image for the dress. An author user may also grab one or more points and move it so as not to adjust shape but move the point at that time in the video, to accomplish having the object follow the image during movement.

One or more computing platforms may be included in system 100. They may be used to perform the functions of and tangibly embody the article, apparatus and methods described herein, such as those described with reference to FIGS. 1-11, such as but not limited to, backend server 106 or web user app 104, although the scope of claimed subject matter is not limited in this respect. A computing platform may be utilized to embody tangibly a computer program and/or graphical user interface, such as web portal 105, by providing hardware components on which the computer program and/or GUI may be executed. A computing platform may be utilized to embody tangibly all or a portion of FIGS. 1-11 and/or other methods or procedures disclosed herein. Such a procedure, computer program and/or machine readable instructions may be stored tangibly on a computer and/or machine readable storage medium such as a flash memory, cloud memory, compact disk (CD), digital versatile disk (DVD), flash memory device, hard disk drive (HDD), and so on. Memory may include one or more auxiliary memories. Memory may provide storage of instructions and data for one or more programs to be executed by the processor, such as all or a portion of that described with reference to FIGS. 1-11 and/or other procedures disclosed herein. Various types of memory are possible, such as by way of example, semiconductor-based memory such as dynamic random access memory (DRAM) and/or static random access memory (SRAM), synchronous dynamic random access memory (SDRAM), Rambus dynamic random access memory (RDRAM), ferroelectric random access memory (FRAM), and so on. Alternatively, or additionally, memory may comprise magnetic-based memory (such as a magnetic disc memory or a magnetic tape memory); an optical-based memory (such as a compact disc read write memory); a magneto-optical-based memory (such as a memory formed of ferromagnetic material read by a laser); a phase-change-based memory (such as phase change memory (PRAM)); a holographic-based memory (such as rewritable holographic storage utilizing the photorefractive effect in crystals); a molecular-based memory (such as polymer-based memories); and/or a remote or cloud based memory and/or the like. Auxiliary memories may be utilized to store instructions and/or data that are to be loaded into the memory before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM, and/or non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and others. Other varieties of memory devices and their future developments are contemplated as well, and claimed subject matter is not intended to be limited to this one possible tangible memory medium.

Backend server 106 and/or a computing platform of web user apps 104 may be controlled by a processor, including one or more auxiliary processors. For example, the method of FIG. 5 described above may be performed, at least in part, by use of a processor. A processor may comprise a central processing unit (CPU) such as a microprocessor or microcontroller for executing programs, performing data manipulations, and/or controlling the tasks of the computing platform. Auxiliary processors may manage input/output, perform floating point mathematical operations, manage digital signals, perform fast execution of signal processing algorithms, operate as a back-end processor and/or a slave-type processor subordinate to a processor, operate as an additional microprocessor and/or controller for dual and/or multiple processor system and/or operate as a coprocessor and/or additional processor. Auxiliary processors may be discrete processors and/or may be arranged in the same package as a main processor, such as by way of example, in a multicore and/or multithreaded processor. Claimed subject matter is not limited by a specific processor example of a specific computing platform example.

Communication with a processor may be implemented via a bus for transferring information among the components of the computing platform. A bus may include a data channel for facilitating information transfer between storage and other peripheral components of the computing platform. A bus may further provide a set of signals utilized for communication with a processor, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100 and later developed standards. Claimed subject matter is not limited to these particular examples.

The computing platform further may include a display for displaying the GUI of web portal 105, such as event area 300, the source files upon a video playing area, and/or listings and reports described with respect to FIGS. 1-11 above. The display may comprise a video display adapter having components, including video memory (such as video random access memory (VRAM), synchronous graphics random access memory (SGRAM), windows random access memory (WRAM) and others), a buffer, and/or a graphics engine. The display may comprise a cathode ray-tube (CRT) type display such as a monitor and/or television and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and any others known in the art. The display may be a touch screen display. The display is capable of displaying a web browser and video player.

The computing platform further may include one or more I/O devices, such as a keyboard, touch screen, stylus, electroacoustic transducer, microphone, speaker, audio amplifier, mouse, pointing device, bar code reader/scanner, infrared (IR) scanner, radio-frequency (RF) device, and/or the like. The I/O devices may be used for inputting data, such as claims information, into the system. There may be an external interface, which may comprise one or more controllers and/or adapters to prove interface functions between multiple I/O devices, such as a serial port, parallel port, universal serial bus (USB) port, charge coupled device (CCD) reader, scanner, compact disc (CD), compact disk read-only memory (CD-ROM), digital versatile disc (DVD), video capture device, T tuner card, 802x3 devices, and/or IEEE 1394 serial bus port, infrared port, network adapter, printer adapter, radio-frequency (RF) communications adapter, universal asynchronous receiver-transmitter (UART) port, and newer developments thereof, and/or the like, to interface between corresponding I/O devices.

As used herein, computing platform and computer readable storage media do not cover signals or other such unpatentable subject matter. Only non-transitory computer readable storage media is intended within the scope and spirit of claimed subject matter.

A computing platform may include more and/or fewer components than those discussed herein. Claimed subject matter is not intended to be limited to this particular example of a computing platform that may be used with the system, article and methods described herein.

The one or more web user app 104 computing platforms of system 100 or 400 may be in remote communication with backend server 106. For example, various computing platforms may be used to access data of system 100 or 400, display event-driven content on web portal 105 by backend server 106 performing the method of FIG. 5.

A web user app 104 computing platform may be used to input data, such as event 102 information. Computing platform may be any computing device, desktop computer, laptop computer, tablet, mobile device, handheld device, PDA, cellular device, smartphone, scanner or any other device known in the art that is capable of being used to input data, such as into a web based portal 105. The user device may be capable of accepting user input or electronically transmitted data. The user device may be used to upload data to backend server 106 and/or receive data from backend server 106 via a network. Various users may operate different computing platforms within system 100 or 400.

The GUIs of FIGS. 6-11 and/or web portal 105 may be viewed upon various known and future developed media players, and is video player agnostic—meaning that it can be played on many media players and is not coded to a specific format (Quicktime, Flash, Windows Media Player, etc.) One example is a HTML 5 based GUI, which may be displayed on various browser platforms. Known embedded interactive content embedded in video files created by methods known in the art typically are media player specific and coded for a particular media player, rather than being HTML content playable within various web browsers. The present system creates interactive video content viewable via software and/or applications on various types of computing platforms (computers, tablets, mobile devices, etc.) and with various operating systems known.

It will, of course, be understood that, although particular examples have just been described, the claimed subject matter is not limited in scope to a particular example or implementation. For example, one example may be in hardware, such as implemented to operate on a device or combination of devices, for example, and another example may be in software. Likewise, an example may be implemented in firmware, or as any combination of hardware, software, and/or firmware. Another example may comprise one or more articles, such as a storage medium or storage media such as one or more SD cards and/or networked disks, which may have stored thereon instructions that if executed by a system, such as a computer system, computing platform, or other system, may result in the system performing methods and/or displaying a user interface in accordance with claimed subject matter. Such techniques may comprise one or more methods for electronically processing the methods for funding life insurance premiums with fixed structured settlements functionality described herein.

In the preceding description, various examples of the present methods, apparatus article have been described. For purposes of explanation, specific examples, numbers, systems, platforms and/or configurations were set forth to provide an understanding of claimed subject matter. Computer file types and languages, and operating system examples, to the extent used, have been used for purposes of illustrating a particular example. However, it should be apparent to one skilled in the art having the benefit of this disclosure that claimed subject matter may be practiced with many other computer languages, operating systems, file types, and without these specific details. in other instances, features that would be understood by one of ordinary skill were omitted or simplified so as not to Obscure claimed subject matter. While certain features have been illustrated or described herein, many modifications, substitutions, changes or equivalents will now occur to those skilled in the art, particularly with reference to the specific computing platform example described herein. The present system, article and method may be tangibly embodied with other computing platforms and future developments thereto. This application is not intended to be limited to the particular computer hardware, functionality and methodology described herein, and is not intended to cover subject matter outside of the limitations to patentability set by 35 U.S.C. 101.

1. A tool for creating interactive content to be displayed with a video, audio and/or picture source file comprising:
a backend server configured to provide instructions to a client's computing platform for authoring event-driven content, mapping the event-driven content to the source file, and synchronizing the event-driven content to the source file based upon business rules, response rules, instructions and/or pointers stored in a database of the backend server;
the backend server further comprising an authoring tool configured to generate one or more event-driven content actions associated with an event in an event area, the event comprising input data received by the backend server indicating user selection during display of the source file, the event area comprising an area within which an event triggers display of the event-driven content;
the authoring tool is configured to create the event-driven content enabled upon the source file without downloading or installing hardware or software on the client's computing platform or sending the source file to a third-party service provider for packaging embedded code files with the source file, and without encoding, decoding or hosting the source file for adding the event-driven content; and
the authoring tool is configured to add new event-driven content to the source file and/or to edit the event-driven content, without requiring the client computing platform to reproduce the source file with the event-driven content by encoding, decoding or packaging it.

2. The tool of claim 1, the event further comprising video start, video click, video stop, video pause, video play, mouse-click, mouse-over, touching a touchscreen, a keystroke, keyboard typing, other data input, generating a specific sound or speech and/or a timed event.

3. The tool of claim 1 further configured to mark one or more positions and/or timings within the source file for the event area for triggering display of the event-driven content.

4. The tool of claim 1 further configured to overlay one or more visual markers on the source file to appear during its display to indicate event-driven content, the visual marker having (x,y,time) coordinates.

5. The tool of claim 1, the backend server is further configured to provide instructions for displaying different event-driven content for different web user computing platforms based upon the business rules, the response rules, and/or a geographic location of the web user computing platform.

6. The tool of claim 1, further configured to display the event-driven content and the source file in real time for dynamic editing of the event-driven content without generating a preview.

7. The tool of claim 1 further configured to tag an object or image that is moving in the video source file during play, the authoring tool configured to dynamically edit the tagged object or image, if the object or image changes shape over a period of time, by adjusting an event area for the object or image over time in size as the video plays without requiring a frame-by-frame editing of the object or image shape.

8. The tool of claim 7 further comprising a slow play button in a tool bar, which is adapted to edit the event area to follow the object or image as it is moving inside of the video to change a size of the event area as the event area moves.

9. The tool of claim 1, further comprising a free hand drawing feature adapted for creating irregular shaped objects with multiple points, the multiple points adapted for being individually moved to edit the object in size and shape without having to draw new image if the object or image of the video source file changes size or shape as it moves during play of the video source file.

10. The tool of claim 1, the event-driven content comprising content from a third party website comprising image content, text content, product information, product pricing information, and/or product sales/purchasing capabilities accessible via clicking through a visual marker associated with the event-driven content, to a separate third party website.

11. The tool of claim 1 further configured to display event-driven content while playing the source file, without stopping play of the video source file or opening up a new web browser window.

12. The tool of claim 1 further comprising a graphical user interface comprising: a field for identification of a location data for where a web user application viewing the event-driven content and the source file is taken when selecting the event-driven content, the location data comprising a URL and is stored in a library;
a source field for identification of a URL for the web location for where the source file is located, the URL data is stored in the library;
a timeline for viewing the timing of when event-driven content and/or visual markers are to be displayed during display of the source file;
one or more controls for creating the event area identifying the area configured for selection during display of the source file for triggering display of the event-driven content, the event area having (x,y,time) coordinates; and
one or more controls for creating one or more visual markers associated with the event-driven content.

13. The tool of claim 1, the authoring tool configured to use object identification enabling for the source file to provide the event-driven content.

14. The tool of claim 1, the authoring tool further comprising one or more tagging controls for use in tagging one or more items or objects in the source file, for adding event-driven content.

15. A system comprising:
a web user application configured to be downloadable to one or more web user computing platforms;
a web portal with a graphical user interface configured for display by the web user application, the web portal configured to receive one or more events from the web user computing platforms, the event comprising a user input received by the computing platform;
a backend server, the backend server having a database comprising business rules, response rules, instructions and/or pointers for client side creation of event-driven content, client side enabling of the event-driven content upon one or more video, audio and/or picture source files, and displaying of the event-driven content on the web portal;
the backend server further comprising a response server adapted to receive the event from the web user computing platforms, the response server configured to process the event to create one or more actions, the event processing is based at least part upon one or more event areas comprising an area defined in the source file that is displayed on the graphical user interface within which selection by a user triggers display of the event-driven content, the action adapted to be communicated by the response server to the web user application via the web portal, the action comprising display of the event-driven content on the web portal; and
the backend server further configured for server side processing of the event-driven content, and not client side processing of encoded embedded event-driven content that is packaged on the server side and sent to the client side for executing.

16. The system of claim 15, the response server, in response to receiving an event from the web application on the web user computing platform, is configured to register the event in a registration log, detect the web user application based upon identifying data for the particular web user application, determine an object detection mechanism based upon an event type of the event, and perform object detection using the object detection mechanism for the particular event type;
the object detection comprising determination of whether the event was generated in the event area based upon positioning of one or more event areas enabled upon a playing area for the source file, the event area is displayed in a time-based manner during display of the source file;
the response server further configured to generate one or more calculated properties for the event based upon the business rules related to the IP address of the web user computing platform; and
the response server is further configured to resolve one or more actions for the event, the action comprising one or more predefined responses to the event based upon event type, one or more of the business rules, instructions and or data stored in the database of the backend server, the actions may be changed for a source file, based upon applying one or more different business rules, response rules, instructions and/or pointer data.

17. The system of claim 15, the action comprising generating instructions for the event-driven content to be displayed on the graphical user interface of the web portal, generating instructions for the web portal to jump to a specific URL or web page, and/or generating instructions to launch one or more applications.

18. The system of claim 15, the business rules comprising rules requiring the web user to select event-driven content in a particular order, rules requiring the web user to display the entire source file prior to displaying any of the event-driven content, one or more event dependent actions comprising actions that will occur based on previously generated events, one or more time dependent actions comprising actions that will only occur at one or more specific times during display of the source file, one ore geographically dependent actions comprising actions that result only if a web user computing platform is located within a specific geographic location, and/or one or more counter dependent actions comprising actions resulting if video play of a video source file is within a specific umber of events.

19. The system of claim 15, the event processing by the response server further based upon specific video defined information incorporated into the source video comprising video duration, video height and/or video width during playing.

20. The system of claim 15, further comprising a visual marker associated with the event-driven content, the visual marker appearing substantially within the event area, the event triggering display of the event-driven content comprising selection of the visual marker.

21. The system of claim 15, the backend server further comprising:
an authoring tool configured for generating the event-driven content, the authoring tool configured to provide instructions to the web user's computing platform for authoring event-driven content, mapping the event-driven content to the source file, and synchronizing the event-driven content to the source file based upon the business rules, response rules, instructions and/or pointers stored in the database of the backend server;
the authoring tool is configured to generate multiple event-driven content actions for a single event;
the authoring tool is configured to create the event-driven content enabled upon the source file without downloading or installing hardware or software on the web user's computing platform or sending the source file to a third-party service provider for packaging embedded code files with the source file, and without encoding, decoding or hosting the source file for adding the event-driven content; and
the authoring tool is configured to add new event-driven content to the source file and/or to edit the event-driven content, without requiring the web user computing platform to reproduce the source file with the event-driven content by encoding, decoding or packaging it.

22. The system of claim 15, the backend server further comprising a management system adapted to age creation, editing and/or deleting of the event-driven content, the management system configured to change the event-driven content for a source file, based upon applying one or more different business rules, response rules, instructions and/or pointer data stored in the database of the backend server.

23. The system of claim 22, the management system comprising a registration log, the management system recording the events and actions in the registration log, storing event data and action data in the registration log.

24. The system of claims 15, the backend server further comprising an analytics tool adapted to capture, store and/or display data associated with the event; and
the analytics tool further comprising a tracking application configured to gather, assess, organize and/or report analytical data about the web user application including user behavior using the web user application, geographic location of the web user computing platforms, the events, timing of the events, order of the events, whether an event produces an action to display the event-driven content, and/or whether an event does not produce the action comprising if a web user selects an area of the graphical user interface that is not within the event area.

25. The system of claim 24, the analytics tool further configured to record and analyze metrics data including but not limited to, where/when the web user application accesses or views objects, video play/stop/pause information; order of interaction with the events; false click information if the web user application receives an attempt to click on an image/object even if there if not any event-based content in that position on the graphical user interface of the web portal at the time of the selection, and/or the web user application click through to one or more third party websites.

26. The system of claim 15, the event selected from the group consisting essentially of a click-through event, a video start event, a video pause event, a video stop event, a picture click event, an audio start event, an audio pause, an audio stop event and a timed event.

27. The system of claim 15, the event comprising one or more inherited properties and one or more calculated properties, the one or more inherited properties comprising an IP address of the computing platform of the web user application generating the event, a unique user identifier, and/or an event time stamp, and the one or more calculated properties based upon event properties and the one or more inherited properties, the one or more calculated properties comprising geographic location of the computing platform and/or local time of the computing platform.

28. The system of claim 15, the event-driven content comprising different content for different web user applications for a particular source file, based upon the business rules, response rules, instructions and/or pointer data.

29. The system of claim 15 further comprising a customer webpage on a customer website that is in remote communication with the web user application and the backend server, the one or more even s communicated from the customer webpage to the backend server, the one or more actions communicated from the backend server to the customer page, the web portal configured for viewing by web user applications as part of the customer webpage.

30. The system of claim 15 further comprising a library of the event-driven content and/or visual marker data, the library comprising one or more databases of the event-driven content and/or the visual marker data, instructions for retrieving the one or more event-driven content and/or the visual markers from memory, and/or instructions for retrieving the source files from memory; and
the backend server configured to provide instructions for accessing one or more event-driven content from the library for creating and/or displaying event-driven content enabled for a source file.

31. The system of claim 15 further comprising a video repository comprising one or more databases or memory for storing the source files that is remote from the backend server; the backend server configured to provide instructions for accessing one or more source files from the video repository for creating and/or playing event-driven content enabled for a source file stored in the video repository; and the source files from the video repository configured for display on the web portal.
